(19) United States
(12) Patent Application Publication
(10) Pub. No.: US 2002/0164510 A1
(43) Pub. Date: Nov. 7, 2002

(54) Fuel cell installation and associated operating method

(76) Inventors: Rolf Brueck, Bergisch Gladbach (DE); Joachim Grosse, Erlangen (DE); Joerg-Roman Konieczny, Siegburg (DE); Meike Reizig, Erpel (DE)

Correspondence Address: GRNER AND GREENBERG, PA, PATENT ATTORNEYS AND ATTORNEYS AT LAW, 2445 Hollywood Boulevard, Hollywood, FL, 33020, US

(21) Appl. No.: 10/042,020

(22) Filed: Jan. 7, 2002

Related U.S. Application Data
(63) Continuation of application No. PCT/DE00/02179, filed on Jul. 4, 2000.

(30) Foreign Application Priority Data
Jul. 5, 1999 (DE) 199 30 876.4

(51) Int. Cl. H01M 8/04; H01M 8/12

(52) U.S. Cl. 429/24; 429/30; 429/13

(57) ABSTRACT

The device and the method determine the temperature in a fuel cell installation. The temperature is recorded at least at one measurement location, such as a position and/or an region of a fuel cell stack and/or of a fuel cell unit, and is transmitted to a computation unit for a model computation. The computation unit then determines the temperature distribution in the stack with the aid of a model computation and transmits the information to a control unit. The control unit can be used to control the temperature in the stack.

### CROSS-REFERENCE TO RELATED APPLICATION

This application is a continuation of copending International Application No. PCT/DE00/02179, filed Jul. 4, 2000, which designated the United States.

### BACKGROUND OF THE INVENTION

1. Field of the Invention:

The invention relates to a fuel cell installation having a device for determining the temperature, which records the temperature at least at one measurement location, such as a position and/or an area of a fuel cell stack and/or of a fuel cell unit, and transmits it to a computation unit for model computation, the computation unit then working out the temperature distribution in the stack with the aid of the model computation. In addition, the invention also relates to the operating method which is to be carried out specifically for this fuel cell installation.

The calculation and modeling of temperature distribution for a fuel cell installation, specifically when realized using PEM (polymer electrolyte membrane) fuel cells, is described in the publication “Modelling of Temperature Distribution in a Solid Polymer Electrolyte Fuel Cell Stack”, Journal of Power Sources 62 (1996), pages 167-74. Furthermore, U.S. Pat. No. 4,640,873 describes temperature monitoring in electricity-generation systems using fuel cells.

In practice, hitherto, the temperature of a fuel cell stack has been determined at one position of the stack, for example at the end plates of the stack, or on the basis of the temperature of the emerging exhaust gases. However, this does not take generally account of the fact that there are temperature gradients within the fuel cell stack and within a fuel cell unit, which gradients result, inter alia, from the exothermic reaction, the cooling and/or the temperature of the inflowing process gases. According to the prior art method for temperature measurement in the fuel cell stack, the temperature distribution is not taken into account, since, with regard to the temperature measurement, the starting point in an initial approximation is a uniform temperature distribution in the stack and/or in the fuel cell unit.

A consequence of this inaccurate temperature measurement is that temperature control in the stack is in some cases incorrect or in some cases highly delayed, and this not only reduces the efficiency of the stack but also the service life of the structural components, on account of excessive stresses being imposed on the material.

It has been established that the efficiency requirements imposed on a fuel cell, specifically for an HTM (High-Temperature Membrane) fuel cell which comprises a polymer electrolyte, require improved temperature recording and/or control.

An HTM fuel cell is described in the commonly assigned international application PCT/DE00/02162, which is herewith incorporated by reference. That application deals in particular with the way in which these specific fuel cells operate. In addition, an overview of various types of fuel cells and their operating temperatures is provided in the monograph “Fuel Cells and Their Applications” (VCH 1996), Table 4-1. Accordingly, in particular the PEM (Polymer Electrolyte Membrane) fuel cells, at standard pressure, operate at temperatures of between 50° C. and 80° C., or at any rate at temperatures of less than 100° C. In conventional PEM fuel cell installations of this type, the process gases have to be humidified, and in this case simulations of the temperature distribution according to the prior art are taken into account. As a result, the process gases can be preheated simultaneously, in order to avoid an undesired temperature gradient, so that the process gases do not flow to the fuel cell stack and/or the fuel cell units at a cold, i.e. ambient temperature, but rather they are at the operating temperature of the stack or fuel cell units. In a new generation of PEM fuel cells, which operate at temperatures of over 100° C. and are known as HTM (High-Temperature Membrane) or HT-PEM (High-Temperature Polymer Electrolyte Membrane) fuel cells, the humidification of the process gases is advantageously eliminated, since this fuel cell operates independently of the water content of the cell.

### SUMMARY OF THE INVENTION

It is accordingly an object of the invention to provide a fuel cell plant and an operating method, which overcome the above-mentioned disadvantages of the heretofore-known devices and methods of this general type and which enable determining and/or controlling the temperature in fuel cell stacks in which temperatures of over 100° C. are used and which eliminate the above-mentioned drawbacks of the dependency on the water content.

With the foregoing and other objects in view there is provided, in accordance with the invention, a combination of an HTM fuel cell installation and a device for determining a temperature in the HTM fuel cell installation. The device comprises:

a temperature detection device disposed to record a temperature of at least one measurement location in the HTM fuel cell installation;

a computation unit for model computation connected to the temperature detection device and receiving a signal from the temperature detection device;

the computation unit being programmed to determine a temperature distribution in the HTM fuel cell installation with a model computation; and

a control unit connected to the computation unit, the control unit regulating at least one parameter of the HTM fuel cell installation selected from the group consisting of an HTM fuel cell voltage, a process-gas supply, a process-gas temperature, a process-gas composition, a quantity of coolant, a coolant composition, and a coolant temperature.

Therefore, the invention relates to a fuel cell installation of the type described in the introduction, in which the fuel cell unit is an HTM fuel cell and/or the fuel cell stack comprises an HTM fuel cell, and in which a control unit can be used to control the cell voltage, the process-gas supply, the process-gas temperature, the process-gas composition, the quantity of coolant, the coolant composition and/or the coolant temperature of the HTM fuel cell stack and/or of the HTM fuel cell unit.

The invention also relates to a method for dynamically controlling the temperature and/or the composition of the process gas of a fuel cell installation, in which the temperature of an HTM fuel cell stack and/or the composition of the process gas is determined within an HTM fuel cell stack and/or an HTM fuel cell unit, this information is transmitted to a control unit directly or via a computation unit for the model computation, the control unit compares at least one input actual value with a predetermined desired value and actuates at least one corresponding control device in such a way that the actual value is made to approach the desired value.

According to one configuration of the invention, the HTM fuel cell installation comprises at least one means for directly determining the temperature, such as a thermocouple, a temperature probe and/or a temperature sensor. In this configuration, at least one such means is arranged, for example, in a representative area of a gas supply or disposal duct of a stack, in a reaction chamber, on an active surface, on a terminal plate and/or at another representative position of one or more, or all of the, fuel cell units of a stack. According to a variant, in this configuration a means for gas analysis, such as a gas sensor, is combined with the means for direct temperature recording, so that at the same time as the temperature, for example of the process gas, in the representative area, its composition can also be determined.

According to another configuration of the invention, the HTM fuel cell installation comprises at least one means for indirectly determining the temperature, for example a means which provides an indication of

the electric load currently being dealt with,

the current cell voltage,

the current coolant consumption,

the current coolant heating and/or

the current H2 flow rate,

the O2 partial pressure

of the relevant representative position or of the representative region or area of the fuel cell unit and/or of the stack.

In the fuel cell installation according to the invention, therefore, the device mentioned transmits the information about at least one current measured temperature value which has been determined as an “actual value” to a computation unit for a model computation, so that the model can be used to extrapolate the temperature distribution in the remainder of the stack and/or in the remaining fuel cell unit. The calculated temperature distribution is then transmitted to a control unit, which can be used to control the cell voltage, the process-gas temperature and supply and/or the process-gas composition, the quantity of coolant, the coolant composition or temperature, etc. In the control unit, a desired value for the temperature distribution is calculated for the corresponding operating state. The algorithm used to calculate the desired value is variable; it can determine different desired values for an operating state at a representative position and/or at a representative area depending on the efficiency of the system, on the power, be it thermal or electric, on the dynamics of the system, etc. The control unit can automatically set one of these desired values by actuating control devices or it can show the result of desired and actual values and an operator can use this information to carry out the actuation of a control device himself (in some cases following a proposal made by the control unit).

Each of the items of data (temperature, coolant consumption and/or temperature and/or heating, H2 flow rate, electric load, cell voltage, current delivery, etc.), and in particular a plurality of these current items of data from the HTM fuel cell stack and/or from the HTM fuel cell unit together, enable the control unit, once it has been fed with this information and/or with the information from the computation unit, to actively, directly and dynamically regulate the current temperature distribution in the fuel cell stack.

With the above and other objects of the invention, there is also provided a method of dynamically controlling a fuel cell installation, which comprises:

determining at least one process parameter in an HTM fuel cell installation, the parameter selected from the group consisting of a temperature of an HTM fuel cell and a composition of a process gas;

transmitting information of the process parameter to a control unit as an input actual value;

comparing, with the control unit, at least one input actual value with a predetermined desired value and actuating at least one corresponding control device of the fuel cell installation such that the actual value is made to approach the desired value.

The information may be transmitted directly to the control unit, or via a computation unit for model computation.

Other features which are considered as characteristic for the invention are set forth in the appended claims.

Although the invention is described herein as embodied in a fuel cell installation and an associated operating method, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments of the invention.

According to one embodiment of the invention, the temperature is determined at two representative positions of the HTM fuel stack and/or of the HTM fuel cell unit. The term “representative position and/or region” is intended to indicate any location or part of a fuel cell stack which, according to one configuration of the invention together with a “pendant”, i.e. an opposite piece, provides information which is as accurate as possible about the current profile of the temperature distribution between the at least two representative positions/areas under consideration in the stack and/or in the fuel cell unit to the computation unit. Typical representative positions or areas are the gas inlet and/or outlet of a cell and a fuel cell unit arranged in the periphery of the stack and a fuel cell unit arranged in the center of the stack.

The term “control device” is intended to indicate, for example, a device for adjusting a metering valve which is arranged in the process-gas feed duct. Another example is an appliance for controlling the current for an electric motor which drives a compressor and the rotational speed of which can be used to control the amount of air flowing in. Similar examples relating to the cooling and the cell voltage, etc., are known to those of skill in the pertinent art.

The term “process gas”, in contrast to the reaction gas, denotes the gas stream which flows through the cells and which, in addition to the reaction gas, may also contain inert gas, contamination, humidification and/or product water in gas and/or liquid form.

The term “desired value”denotes the temperature value at the representative position which has been determined using the computation model of the control unit with a certain aim, such as optimizing the efficiency, the output, and the like of the fuel cell and/or of the system at the representative position/location or region.

The results of the determination of the temperature are continuously input to the control unit. The control unit is able, on the basis of the control electronics available to it, to determine a temperature (the desired value) which, for example, ensures optimum efficiency of the system, for each operating state and each representative position. Furthermore, the control unit is able to decide, on the basis of the input information, which control device can be used to carry out the correction of the temperature at the relevant position most quickly, and can selectively and/or in combination increase the supply of coolant, restrict the supply of process gas, reduce the cell voltage, etc. However, the automation of the control electronics of the control unit can also be replaced by a temperature stipulation and/or a manual actuation of a control device, so that, for example, the operators (e.g. a driver's) wishes or the temperature stipulation of a stationary system can also be taken into account, under certain circumstances to the detriment of, for example, the efficiency of the system.

With the present device and the present method of active temperature control, it is possible to optimize an HTM fuel cell installation with regard to the temperature. This optimization proves equally successful for use of the installation in stationary and mobile systems.

We claim:

1. In an HTM fuel cell installation, a device for determining a temperature in the HTM fuel cell installation, comprising:
a temperature detection device disposed to record a temperature of at least one measurement location in the HTM fuel cell installation;
a computation unit for model computation connected to said temperature detection device and receiving a signal from said temperature detection device;
said computation unit being programmed to determine a temperature distribution in the HTM fuel cell installation with a model computation; and
a control unit connected to said computation unit, said control unit regulating at least one parameter of the HTM fuel cell installation selected from the group consisting of an HTM fuel cell voltage, a process-gas supply, a process-gas temperature, a process-gas composition, a quantity of coolant, a coolant composition, and a coolant temperature.

2. The combination according to claim 1, wherein the HTM fuel cell installation comprises an HTM fuel cell.

3. The combination according to claim 1, wherein the HTM fuel cell installation comprises an HTM fuel cell stack.

4. The combination according to claim 1, wherein said measurement location is defined at a given position of the fuel cell installation.

5. The combination according to claim 1, wherein said measurement location encompasses a given region within the fuel cell installation.

6. The combination according to claim 1, wherein said temperature detection device includes at least two means for determining the temperature.

7. The combination according to claim 1, wherein said temperature detection device includes at least one device for direct temperature measurement selected from the group consisting of a thermocouple, a temperature probe, and a temperature sensor.

8. The combination according to claim 7, wherein a gas analyzer is integrated in said device for direct temperature measurement.

9. The combination according to claim 1, which comprises at least one means for indirectly determining the temperature.

10. A method of dynamically controlling a fuel cell installation, which comprises:
determining at least one process parameter in an HTM fuel cell installation, the parameter selected from the group consisting of a temperature of an HTM fuel cell and a composition of a process gas;
transmitting information of the process parameter to a control unit as an input actual value;
comparing, with the control unit, at least one input actual value with a predetermined desired value and actuating at least one corresponding control device of the fuel cell installation such that the actual value is made to approach the desired value.

11. The method according to claim 10, which comprises transmitting the information directly to the control unit.

12. The method according to claim 10, which comprises transmitting the information to the control unit via a computation unit for model computation.

13. The method according to claim 10, which comprises determining the parameter for an HTM fuel cell stack.

14. The method according to claim 10, which comprises determining the parameter for an HTM fuel cell.

15. The method according to claim 10, which comprises determining a temperature distribution in a fuel cell stack with a device selected from the group consisting of a temperature measurement device and a gas composition determination device, from information provided by one of the control unit and a computation unit for model computation.
